(19) United States
(12) Patent Application Publication
(10) Pub. No.: US 2025/0203399 A1
(43) Pub. Date: Jun. 19, 2025

(54) AI/ML BASED PREDICTION FOR COMPENSATING CHANNEL AGING IN NON-TERRESTRIAL NETWORKS

(71) Applicant: Lenovo (Singapore) Pte Limited, Singapore (SG)

(72) Inventors: Sher Ali CHEEMA, Ilmenau (DE); Seyedomid TAGHIZADEH MOTLAGH, Oberursel (DE); Majid GHANBARINEJAD, Chicago, IL (US); Ali Ramadan ALI, Kraiburg am Inn (DE)

(21) Appl. No.: 18/848,024

(22) PCT Filed: Mar. 15, 2023
(86) PCT No.: PCT/US2023/064475

§ 371 Date: Sep. 17, 2024

Related U.S. Application Data
(60) Provisional application No. 63/321,431, filed on Mar. 18, 2022.

(51) Int. Cl. H04W 24/02; H04B 7/06; H04W 84/06

(52) U.S. Cl. CPC H04W 24/02; H04B 7/0626; H04W 84/06

(57) ABSTRACT

Various aspects of the present disclosure relate to utilizing artificial intelligence (AI) and/or machine learning (ML) prediction models when compensating for channel aging in non-terrestrial networks (NTNs). The aspects of the present disclosure can facilitate the selection of a prediction model based on specific conditions or attributes of an NTN, such as parameters associated with a satellite of the NTN and/or weather or atmospheric conditions surrounding the NTN.

### CROSS REFERENCE TO RELATED APPLICATIONS

This application claims priority to U.S. Provisional Patent Application No. 63/321,431, filed on Mar. 18, 2022, entitled AI/ML BASED PREDICTION FOR COMPENSATING CHANNEL AGING IN NON-TERRESTRIAL NETWORKS, which is hereby incorporated by reference in its entirety.

### TECHNICAL FIELD

The present disclosure relates to wireless communications, and more specifically to predicting channel information in non-terrestrial networks (NTNs).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

In NTNs, satellites and other flying objects or vehicles provide a communication network or wireless communications system. These NTNs may include geostationary satellite (GEO) systems, low earth orbit (LEO) systems, or other satellite-based or moving objects, unmanned aerial vehicles (UAVs), high altitude platform systems (HAPS), or other air-to ground networks or flying objects. These systems may be deployed above the earth, at distances from a few hundred meters above the ground (e.g., in the case of UAVs or drones) to hundreds of kilometers or higher (e.g., in the case of GEO systems).

### SUMMARY

The present disclosure relates to methods, apparatuses, and systems that support utilizing artificial intelligence (AI) and/or machine learning (ML) prediction models when compensating for channel aging in NTNs. The methods, apparatuses, and systems can facilitate the selection of a prediction model based on specific conditions or attributes of an NTN, such as parameters associated with a satellite of the NTN and/or weather or atmospheric conditions surrounding the NTN. Thus, the methods, apparatuses, and systems enable an NTN to utilize prediction models for channel state information (CSI) feedback tailored or configured to current conditions and/or geometries of the NTN, resulting in improved or enhanced predictions of CSI feedback and associated optimization or provisioning of the resources of the NTN, among other benefits.

Some implementations of the method and apparatuses described herein may further include receiving one or more parameters associated with an NTN, selecting an artificial intelligence/machine learning (AI/ML) prediction model based on the received one or more parameters for CSI aging compensation, and applying the selected AI/ML prediction model to predict one or more CSI quantities to compensate for CSI aging phenomenon in the NTNs.

In some implementations of the method and apparatuses described herein, the apparatus receives the one or more parameters via radio resource control (RRC) signaling.

In some implementations of the method and apparatuses described herein, the apparatus receives, from a network entity, a system information block (SIB) including the one or more parameters associated with the non-terrestrial network.

In some implementations of the method and apparatuses described herein, the one or more parameters associated with the non-terrestrial network include a current orbit of a satellite of the non-terrestrial network, a current position of the satellite of the non-terrestrial network, or a speed vector defining a current speed of the satellite of the non-terrestrial network, or any combination thereof.

In some implementations of the method and apparatuses described herein, the one or more parameters associated with the non-terrestrial network include a cell layout configuration for one or more cells of the non-terrestrial network, a weather condition within the non-terrestrial network, or an atmospheric condition within the non-terrestrial network, or any combination thereof.

In some implementations of the method and apparatuses described herein, the apparatus comprises a user equipment (UE) associated with a group of UEs for receiving the one or more parameters associated with the non-terrestrial network; and wherein the group of UEs are grouped based on a respective location associated with each respective UE of the group of UEs, a channel aging type associated with each respective UE of the group of UEs, or a respective prediction modeling capability of each respective UE of the group of UEs, or any combination thereof.

In some implementations of the method and apparatuses described herein, the apparatus transmits prediction model capabilities to the NTN.

In some implementations of the method and apparatuses described herein, the apparatus transmits prediction model capabilities and associated model training deficiencies of the apparatus to the NTN.

In some implementations of the method and apparatuses described herein, the apparatus selects the prediction model based on the parameters associated with the NTN and without additional information from the NTN.

In some implementations of the method and apparatuses described herein, the apparatus transmits prediction model capabilities and associated model training deficiencies of the apparatus to the NTN, receives from the NTN prediction scenario information and CSI quantity information, and updates prediction models of the apparatus using the prediction scenario information and CSI quantity information received from the NTN.

In some implementations of the method and apparatuses described herein, the selected prediction model includes a deep neural network model, a linear regression model, a support vector machines model, a learning vector quantization model, or a decision tree model.

Some implementations of the method and apparatuses described herein may further include a network entity of an NTN that receives information from at least one other UE that indicates prediction success rates for the other UE for predictions of one or more CSI quantities for CSI aging compensation, transmits parameters associated with the NTN, and configures an AI/ML prediction model based on the parameters associated with the NTNs or based on the information received from the at least one other UE that that indicates the prediction success rates for the other UE.

In some implementations of the method and apparatuses described herein, the information received from the at least one other UE includes information that identifies the AI/ML prediction models utilized by the at least one other UE when predicting CSI quantities for the NTN.

In some implementations of the method and apparatuses described herein, the at least one other UE includes multiple UEs, and where each of the multiple UEs employs a different machine-learning prediction model for predicting CSI quantities for the NTN, and wherein the information received from the multiple UEs includes information that identifies success rates for the different prediction models utilized by the multiple UEs when predicting the CSI quantities.

In some implementations of the method and apparatuses described herein, the network entity configures the prediction model employed by the UE by adding a prediction model accuracy parameter to a report that identifies from the received information a prediction model having a highest success rate for predicting the one or more CSI quantities for CSI aging compensation of the NTN.

In some implementations of the method and apparatuses described herein, the network entity configures the prediction model employed by the UE by adding a prediction model accuracy parameter to a report that identifies from the received information a prediction model having a highest success rate for predicting the one or more CSI quantities for CSI aging compensation of the NTN.

In some implementations of the method and apparatuses described herein, the network entity sends to the at least one other UE information identifying a time window within which to measure a prediction model output accuracy when the multiple other UE are utilizing prediction models to predict the of one or more CSI quantities for CSI aging compensation of the NTN.

Some implementations of the method and apparatuses described herein may further include a method performed by a network entity of an NTN that receives prediction model capability information from UE and configures, at the UE, an AI/ML prediction model to predict one or more CSI quantities for CSI aging compensation in the NTN.

In some implementations of the method and apparatuses described herein, the network entity configures a unique prediction model for each of multiple CSI quantities to be predicted by the UE.

In some implementations of the method and apparatuses described herein, the network entity configures the UE by transmitting a table using RRC signaling to the UE that identifies two or more CSI quantities to be predicted by the UE.

In some implementations of the method and apparatuses described herein, the network entity configures the UE during a cell handover procedure for the UE.

In some implementations of the method and apparatuses described herein, the network entity configures the UE before performing a hard feeder link switchover for the UE.

### BRIEF DESCRIPTION OF THE DRAWINGS

FIGS. 1A-1B illustrate examples of wireless communications systems that support predicting channel aging compensation quantities for NTNs in accordance with aspects of the present disclosure.

FIG. 2 illustrates an example of a block diagram that supports information exchanges between UE and base stations of NTNs in accordance with aspects of the present disclosure.

FIG. 3 illustrates a flowchart of a method that supports predicting quantities for channel properties of NTNs in accordance with aspects of the present disclosure.

FIG. 4 illustrates a flowchart of a method that supports updating prediction models for UE in accordance with aspects of the present disclosure.

FIG. 5 illustrates an example of a block diagram that supports the configuration of prediction models in UE in accordance with aspects of the present disclosure.

FIGS. 6 and 7 illustrate flowcharts of methods that support configuring prediction models for UE in accordance with aspects of the present disclosure.

FIG. 8 illustrates an example of a block diagram of a UE that supports predicting channel aging compensation quantities for NTNs in accordance with aspects of the present disclosure.

### DETAILED DESCRIPTION

When compared to terrestrial networks, NTNs often have higher reliability requirements and thus tend to rely more heavily on accurate CSI feedback or other channel quality information from associated UE. For example, NTNs can utilize accurate CSI feedback when optimizing network resources provided to the UE (e.g., when the gNB or other network entity of a satellite system schedules the optimal cells or other resources of the NTN for the UE).

However, due to the large distances between UEs and the satellites providing the NTNs, certain issues arise that can prevent accurate or useful CSI reporting or feedback from UEs. GEO systems are often associated with longer transmission delays (RTD), and Doppler effects or other movement affects arise within LEO satellite systems. Because of these and other issues (e.g., UE movement, weather, or atmospheric conditions) inherent in NTNs, the CSI feedback from a UE can be out-of-date (e.g., or aged), resulting in performance loss, among other drawbacks.

For example, MCS (modulation and coding set) selection in downlink transmission at the gNB of a terrestrial network (e.g., a network having line-of-sight channel conditions or stable networks) from CSI feedback reported by a UE can limit the performance of an AMC (adaptive modulating and coding set). However, networks having non-line-of-sight channel conditions, such as NTNs, can be more severely compromised, because the channel ages and CSI feedback becomes out-of-date and thus not useful for scheduling or optimizing resources. For example, when the gNB of an NTN utilizes MCS scheduling information from an aging channel (e.g., aged or out-of-date channel quality indicator (CQI)), the channel can suffer from throughput loss and other issues due to CSI feedback aging or delays.

To avoid using outdated CSI feedback and other channel information when optimizing resources of a network, network system can employ prediction-based techniques to attempt to mitigate or compensate the effects of channel aging in NTNs when a UE measures CSI for the networks. For example, an NTN can employ AI/ML (artificial intelligence and/or machine learning) based prediction models, frameworks, and/or techniques when predicting values for CSI quantities or properties of a channel or cell of the NTN.

As described herein, the systems can employ various signaling aspects or methods when configuring and applying the prediction models to the NTNs. These signaling aspects or methods can facilitate the optimal selection of a prediction model by a UE when performing predictions for CSI quantities.

Further, the selection of a prediction model can be based on specific conditions or attributes of an NTN, such as parameters associated with a satellite of the NTN and/or weather or atmospheric conditions surrounding the NTN. Thus, in some cases, these signaling aspects enable an NTN and associated devices (e.g., the base station or network entity of the NTN) to utilize prediction models for CSI feedback that are tailored or configured to current conditions and/or geometries of the NTN, resulting in improved or enhanced predictions of CSI feedback and associated optimization or provisioning of the resources of the NTN, among other benefits.

Aspects of the present disclosure are described in the context of a wireless communications system. Aspects of the present disclosure are further illustrated and described with reference to the following device diagrams and flowcharts that relate to predicting channel aging compensation quantities for NTNs.

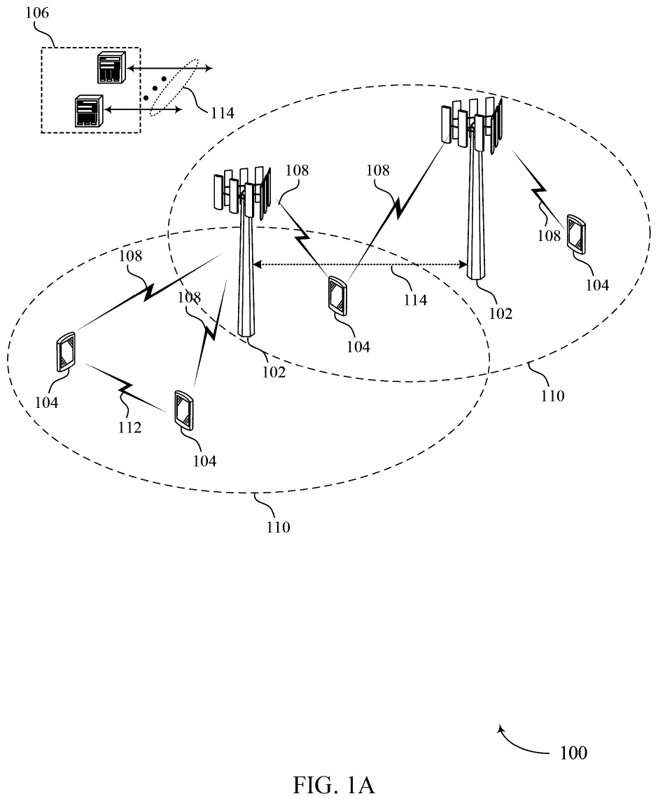

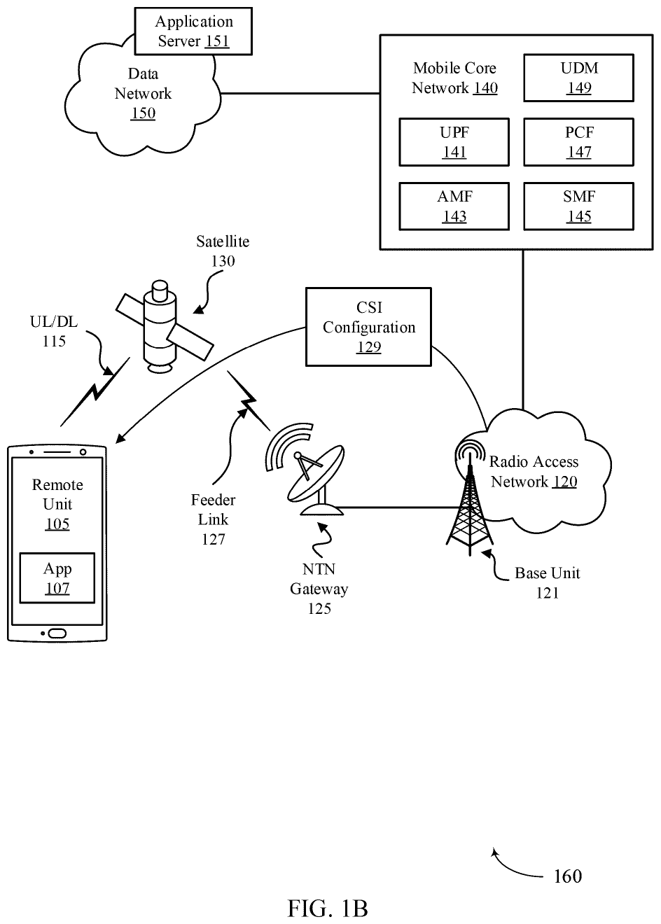

FIG. 1A illustrates an example of a wireless communications system 100 that supports predicting channel aging compensation quantities for NTNs in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with an NTN. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

FIG. 1B illustrates another example of a wireless communications system 160 that supports predicting channel aging compensation quantities for NTNs in accordance with aspects of the present disclosure. The wireless communication system 160 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates via a satellite 130 using wireless communication links 123. As depicted, the mobile communication network includes an “on-ground” base unit 121 which serves the remote unit 105 via satellite access.

In some implementations, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In other implementations, the RAN 120 is compliant with the LTE system specified in the 3GPP specifications. More generally, however, the wireless communication system 160 may implement some other open or proprietary communication network, for example Worldwide Interoperability for Microwave Access (“WiMAX”) or IEEE 802.16-family standards, among other networks.

In some embodiments, the remote units 105 are the user equipment 104 of FIG. 1A and can be referred to as mobile devices or user device. The remote units 105 may communicate directly with one or more of the base units 121 in the RAN 120 via uplink (“UL”) and downlink (“DL”) communication signals. The remote units 105 can communicate in a non-terrestrial network via UL and DL communication signals between the remote unit 105 and a satellite 130.

The satellite 130 may communicate with the RAN 120 via an NTN gateway 125 using UL and DL communication signals between the satellite 130 and the NTN gateway 125. The NTN gateway 125 may communicate directly with the base units 121 in the RAN 120 via UL and DL communication signals. Furthermore, the UL and DL communication signals may be carried over the wireless communication links 123. Here, the RAN 120 is an intermediate network that provides the remote units 105 with access to the mobile core network 140. Moreover, the satellite 130 provides a non-terrestrial network allowing the remote unit 105 to access the mobile core network 140 via satellite access.

While FIG. 1B depicts a transparent NTN system where the satellite 130 repeats the waveform signal for the base unit 121, in other embodiments the satellite 130 (e.g., for a regenerative NTN system), or the NTN gateway 125 (e.g., for an alternative implementation of a transparent NTN system) may also act as base station, depending on the deployed configuration.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120. Note that in the NTN scenario certain RAN entities or functions may be incorporated into the satellite 130. For example, the satellite 130 may be an embodiment of a Non-Terrestrial base station/base unit.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In various implementations, the remote unit 105 receives a CSI configuration 129 from the base unit 121, for measurement and reporting of CSI-RS signals. As described in greater detail below, the CSI configuration 129 may contain a mapping table for dynamic adaptions of the CSI measurement behavior, where the remote unit 105 adjusts its frequency/rate of measurement (i.e., measurement periodicity) and/or its frequency/rate of reporting (i.e., reporting periodicity) based on location and/or signal measurement value.

In some implementations, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various implementations, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various implementations, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain implementations, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIGS. 1A-1B depict components of a 5G RAN and a 5G core network, the described technology applies to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for dynamically adapting a measurement behavior.

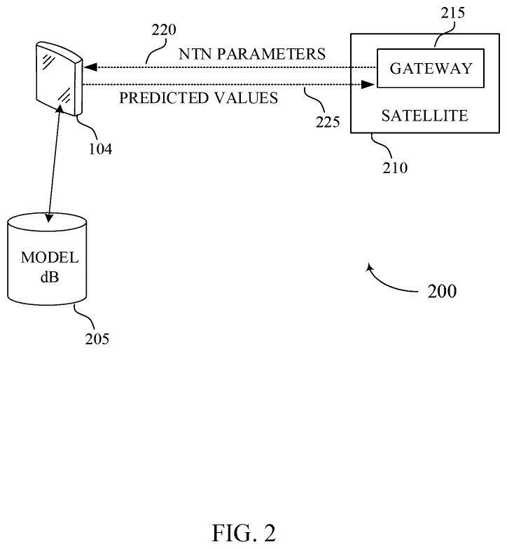

As described herein, the base station 102 or other network entity or gateway can be moveable, such as when part of a satellite or flying object associated with an NTN. FIG. 2 illustrates an example of a block diagram that supports information exchanges between UE and base stations or network gateways of NTNs in accordance with aspects of the present disclosure. These information exchanges, or signaling aspects, facilitate the selection or configuration of prediction models based on parameters associated with an NTN.

A satellite 210 includes a network gateway 215, such as a next-generation NodeB (gNB) and provides an NTN to one or more UEs 104. In some implementations, the satellite 210 is part of a GEO system, a LEO system, or other satellite-based or moving object (e.g., unmanned aerial vehicle, or UAV) systems that provide communication services.

As described herein, applying CSI feedback prediction at UEs can result in lower latency and lower signaling aspects. Further, the exchange or signaling of aspects between UEs and the NTN can enhance or optimize the accuracy of the predictions, such as by selecting AI/ML prediction models based on satellite or other NTN parameters. For example, the UE 104, which is associated with a database of available AI/ML prediction models 205, can receive satellite mobility information and other NTN parameters 220 from the gateway 215 of the satellite 210 of the NTN.

The UE 104, having the NTN parameters 220, can select a prediction model from the database 205, based on the NTN parameters 220. Using the selected prediction model, the UE 104 can apply the prediction model, generate an output of predicted CSI values 225, and transmit the predicted CSI values 225 to the gateway 215 of the network. The gateway 215 can then optimize resources of the network using the predicted CSI values 225.

As illustrated in FIG. 2, the NTN (via the gateway 215 of the satellite 210) and the UE 104 exchange assistance information (e.g., NTN parameters 220 and values 225) useful when applying AI/ML based prediction methodologies to predict the configuration of future reference signals, such as synchronization signal block (SSB) information, CSI reference signal (CSR-RS) information, and sounding reference signal (SRS) information, reporting quantities, such as reference signal received power (RSRP) values and CSI-RS reporting index (CRI) information, and the resulting processes, such as link adaptation by MCS selection for downlink/uplink (DL/UL), and/or other CSI quantities or combinations.

Further, the NTN and the UE 104 can exchange assistance information to inform the network about device capability (for the UE 104) to support AI/ML based prediction methods or models.

To apply efficient and precise AI/ML based prediction methods at the UE 104, the UE receives the NTN parameters 220, such as information about the satellite 210 and/or the environment or atmosphere surround the satellite 210. The gateway 215 can transmit both dynamic (e.g., continuously, or periodically changing) information, as well as static information, for the satellite 210 and other associated information. Example parameters include parameters associated with the (1) satellite orbit, (2) satellite position (e.g., altitude, latitude, and longitude), (3) satellite speed vectors, (4) cell layout configuration and type (e.g., earth fixed cell/beams or earth moving cells with movement parameters), (5) satellite architecture (e.g., based on transparent or regenerative payload), (6) frequency reuse factors, (7) type of cell/beam polarization (e.g., linear, left hand circular, or right hand circular), (8) cell boundary locations or the locations of UEs relative to the cell area, (9) weather/atmospheric conditions, various combinations, and so on.

In some cases, such as based on deployment scenarios for the satellite 210, the UE 104 can receive some or all of the above parameters. For example, the UE 104 can receive dynamic parameters (e.g., satellite orbit and position information, weather condition information, static information (e.g., architecture or cell layout information), or various combinations or subsets of the parameters.

In some implementations, the gateway 215 broadcasts or otherwise transmits the NTN parameters 220 via a SIB, because the SIB is valid/common to the UE 104 and other UEs of a cell or cells of the network. The gateway 215 can associate the parameters 220 to a cell ID, which is accessible the group of UEs of a cell or cells assigned the cell ID.

For example, when the network requires optimization of SSB quantities (e.g., with UEs that are located at beam footprint edges where information regarding the current detected SSB values often are not valid for a time duration larger than a threshold due to movement of the satellite 210), the gateway 215 can transmit certain NTN parameters 220 over via the SIB (e.g., SIB1). The UE 104 can apply one or more of the prediction models using the received parameters 220 to predict or output SSB values having a certain minimum accuracy.

For example, the prediction of the SSB values for the channel by the UE 104 can become more accurate when the prediction is based on parameters that identify satellite ephemeris (e.g., speed, orbit, and so on) and the cell/beam layout configuration that defines whether the beams are moving along with the satellite movement.

In some implementations, the gateway 215 broadcasts or otherwise transmits the NTN parameters 220 via dedicated RRC signaling between the gateway 215 and the UE 104.

In some implementations, the gateway 215 groups the UEs based on their location, the type of channel aging experience by the UEs, their prediction model capabilities, and/or other factors. The gateway 215 can assign a group of UEs a common or group ID and can broadcast the NTN parameters 220 via the RRC signaling along with an identified group ID, such that UEs assigned the group ID receice the NTN parameters 220. Thus, the NTN can utilize group RRC signaling or other grouped information channels (e.g., downlink control information, or DCI) when broadcasting or otherwise transmitting parameters to multiple UEs.

As described herein, in some implementation, the UE 104 transmits model capability information to the network, which applies and configures the AI/ML prediction model by signaling the UE 104 or other UEs 104. The UE 104 can provide the model capability information based upon a request from the network or autonomously. In some cases, the UE 104 sends a bit over an uplink control information (UCI) channel that indicates whether the UE 104 has AI/ML prediction capabilities (e.g., access to one or more AI/ML prediction models) or does not have those capabilities.

In some cases, the UE 104 can indicate, via signaling (e.g., RRC signaling) or via a RACH (random-access channel) procedure (e.g., using PRACH preamble or Msg3), details about the types of prediction models available or usable by the UE 104. For example, a codebook type AI/ML model description can be pre-defined or implemented as a table (e.g., Table 1) or other data structure, with a separate table (e.g., Table 2) or other data structure indicating a list defining applicable scenarios to consider during channel predictions. Following the example, the UE 104 can send information identifying the indices that correspond to the prediction model capabilities of the UE 104, as depicted in the tables.

TABLE 1

| Index | AI/ML Model Architecture |
|---|---|
| 0 | Deep Neural Network |
| 1 | Linear Regression |
| 2 | Support Vector Machines |
| 4 | Learning Vector Quantization |
| 5 | Decision Trees |
| . . . | . . . |

TABLE 2

| Index | Scenarios |
|---|---|
| 0 | Indoor |
| 1 | Outdoor |
| 2 | Rainy Environment |
| 3 | Foggy Environment |
| 4 | Cloudy Environment |
| . . . | . . . |

While the tables relate scenarios to model architectures, the network can indicate scenarios via quantitative parameters measured by the network. Example parameters and how they relate to certain scenarios are depicted as follows:
a range of pathloss values associated with indoor conditions; a range of pathloss values associated with outdoor conditions;
a range of values for delay spread associated with a dense scattering environment (e.g., an urban area); a range of values for delay spread associated with a less dense scattering environment (e.g., a suburban area); a range of values for delay spread associated with a yet less dense scattering environment (e.g., a rural area);
a range of CSI values associated with natural non-residential areas, such as a forest;
a range of values for Doppler spread associated with a non-mobile ground transceiver; a range of values for Doppler spread associated with a mobile ground transceiver;
ranges of atmospheric loss values for rainy weather, foggy weather, cloudy weather, sunny weather, and other weather conditions; and so on.

In some implementations, the UE 104 can indicate, in addition to its prediction model capabilities, which models may benefit from additional training for one or more scenarios or specific quantities, including a number of additional training iterations or samples. The UE 104 can provide a single message that includes the model information and capability information, such as a list of indices (corresponding to the tables) that identify the model capabilities, the supported scenarios, and/or an indication of which models should be trained or otherwise updated (e.g., a 0-bit indicates no training while a 1-bit indicates recommended training for a scenario or scenarios). The UE 104 can provide the information autonomously or upon request from the network.

As described herein, the delay (e.g., RTD) between the UE 104 and the satellite 210 can cause issues with measuring CSI and other quantities of the NTN. Thus, in some implementations, the AI/ML capabilities and/or parameters at the UE 104 or the network can depend on a maximum RTD for the link between the devices. In such cases, one or more parameters can determine or represent the maximum RTD, such as the altitude of the satellite orbit, whether there is a transparent or regenerative payload of the satellite 210, and so on.

In such cases, the network can balance various benefits when selecting or utilizing certain AI/ML prediction models. For example, a certain mode can introduce higher complexity but provide higher robustness or fidelity against longer delays (e.g., RTDs). Thus, the network can select the certain model when average, above average, or maximum link delay (e.g., based on altitude or architecture) causes channel aging, because the network benefits from the accuracy, despite the complexity of the model.

In other cases, the network can utilize certain models for certain weather conditions, where one model is more useful for sunny weather when the satellite 210 is at a certain altitude, while another model is selected when the weather changes. Further, the network can select any model when some parameters associated with the satellite 210 (e.g., the orbit is low) indicate low or below average transmission delays, regardless of weather conditions.

Thus, as described herein, the UE 104 can utilize various AI/ML prediction models (e.g., models from database 205), based on NTN parameter information 220 provided by the NTN (e.g., by the gateway 215 of the satellite 210) when performing CSI feedback predictions to compensate for channel aging within the NTN. As described herein, the UE 104 can utilize predictions for when compensating for the aging (e.g., when values of CSI become out of date or no longer accurate) of different CSI, including Channel Quality Indicators (CQIs), pre-coding matrix indicators (PMIs), pre-coding type indicators (PTIs), ranking indication (RI), and so on. While the network can assist and/or configure the prediction models to be employed by the UE 104 when performing predictions for channel properties of the NTN (as described herein), in some implementations, the UE 104 autonomously selects the prediction models to utilize when performing predictions. The UE 104 can select a model with or without information provided by the network.

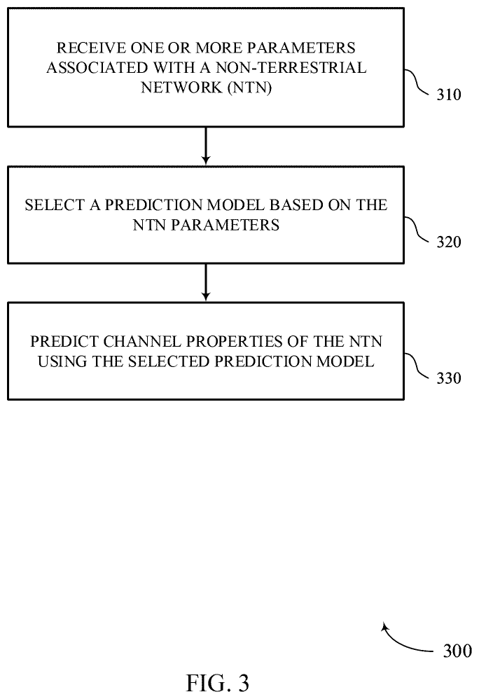

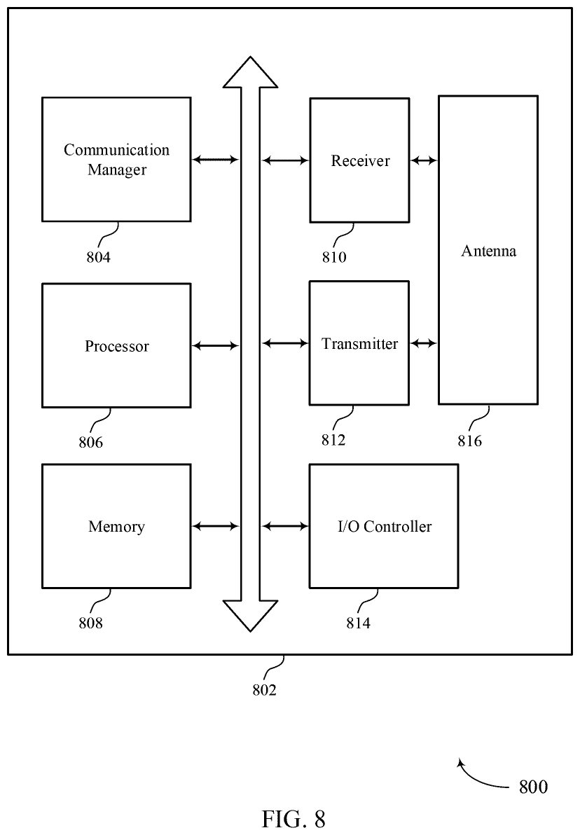

FIG. 3 illustrates a flowchart of a method 300 that supports predicting quantities for channel properties of NTNs in accordance with aspects of the present disclosure. The operations of the method 300 may be implemented by a device or its components as described herein. For example, the operations of the method 300 may be performed by a UE 104 as described with reference to FIG. 8. In some implementations, the device may execute a set of instructions to control the function elements of the device to perform the described functions. Additionally, or alternatively, the device may perform aspects of the described functions using special-purpose hardware.

At operation 310, the method may include the UE receiving one or more parameters associated with an NTN. The operations of step 310 may be performed in accordance with examples as described herein. In some implementations, aspects of the operations of step 310 may be performed by a device as described with reference to FIG. 1.

At operation 320, the method may include selecting a prediction model based on the one or more NTN parameters. The operations of step 320 may be performed in accordance with examples as described herein. In some implementations, aspects of the operations of step 320 may be performed by a device as described with reference to FIG. 1.

At operation 330, the method may include predicting channel properties (e.g., CSI information) of the NTN using the selected prediction model. The operations of step 330 may be performed in accordance with examples as described herein. In some implementations, aspects of the operations of step 330 may be performed by a device as described with reference to FIG. 1.

For example, the UE 104 can select a suitable AI/ML model and the prediction quantity for the application of the selected model. In some cases, the UE 104 can receive rules or assistance information from the network, UE location, or a signal quality parameter, such as an RSRP/RSRQ value. The autonomous selection of models can be useful when avoiding signaling overhead due to exchanges of information between devices, such as when the satellite 210 is associated with a transparent payload. The UE 104, when selecting the prediction model, can indicate the selection to the network along with a prediction output via its reporting configuration.

In some implementation, the UE autonomously selects the AI/ML prediction model, while the network configures/assists the UE with some additional information to assist in the selection or to increase the model prediction accuracy. For example, other than the satellite-related assistance information, the network can configure information about scenarios (e.g., indoor, atmospheric information, and so on) and quantities that to be predicted.

The network can indicate, in a spare bit of the MIB, that the AI/ML based prediction is to be applied for one or multiple channel quantities. For example, a 1 in the spare bit may refer to predictive output for a specific quantity (e.g., SSB) or for all quantities, while a 0 may refer to no prediction-based output for any quantity. The network can also utilize SIB1 and transmit satellite related assistance information along with an index (the index in Table 3, described herein) that indicates a list of quantities for prediction-based output.

In some cases, such as when predication-based output is for CSI related quantities, the network can configure the index corresponding to the quantities through DCI or RRC signaling. As described herein, the network can utilize a common group DCI when configuring the index for a group of UEs.

In some cases, the UE 104 can indicate to the network a request for a prediction model update or model training. The UE 104 can include a request for the provisioning of a model training period, where the satellite 210 includes the correct values of the to-be-predicted values along with the transmission of the related RS or SSB to the UE 104. The network can transmit correct values/labels to the UE with some delay, such as when the network obtains a correct estimation of the parameter (e.g., via obtaining a high-resolution estimation from a larger time window or more input data from other sources, multiple UE reporting, and/or combinations). During the transmission, the network can send a request to store the input parameters for running the prediction model for the specified time-window and use the received label parameters from the network for the purpose of model training.

In some implementations, the UE 104 indicates its capabilities for AIM CSI prediction to the network using an information message, either autonomously or in response to a network request. The UE 104 can indicate the type of the available or supported ML model and/or the available scenario-specific trained models. The information message can include an index defined in Table I (e.g., as the available ML model type), codebook indices, and/or parameters that define the model architecture (e.g., a number of ANN layers, a number of neurons/computational units, a used activation function at the neuron/computational units, model weights, types of scenarios for which the model parameters are trained (e.g., the index of Table 2), and various combinations).

The UE 104 can indicate the available ML prediction model and the supported metrics/parameters that can be predicted using the available model (e.g., the index depicted in Table 3). The UE 104 can indicate the type of possible or need model input parameters and the network provides the UE 104 with the requested input data, with resources/mechanisms to obtain the indicated input parameters, and/or various combinations.

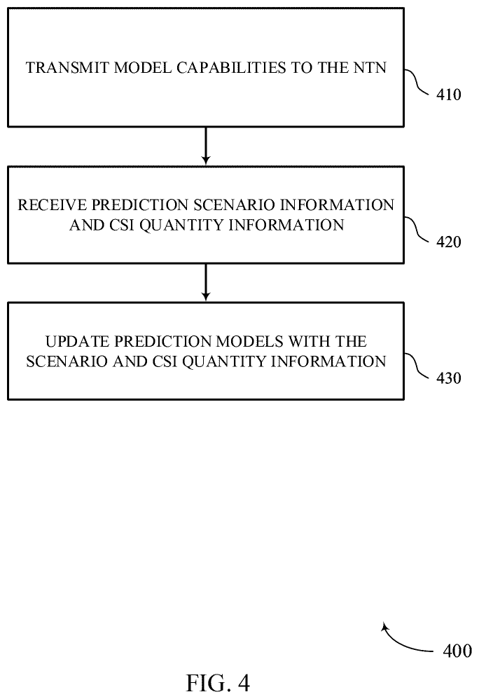

FIG. 4 illustrates a flowchart of a method 400 that supports updating prediction models for UE of NTNs in accordance with aspects of the present disclosure. The operations of the method 400 may be implemented by a device or its components as described herein. For example, the operations of the method 400 may be performed by a UE 104 as described with reference to FIG. 8. In some implementations, the device may execute a set of instructions to control the function elements of the device to perform the described functions. Additionally, or alternatively, the device may perform aspects of the described functions using special-purpose hardware.

At operation 410, the method may include transmitting model capabilities to the NTN. The operations of step 410 may be performed in accordance with examples as described herein. In some implementations, aspects of the operations of step 410 may be performed by a device as described with reference to FIG. 1.

At operation 420, the method may include receiving prediction scenario information and CSI quantity information. The operations of step 420 may be performed in accordance with examples as described herein. In some implementations, aspects of the operations of step 320 may be performed by a device as described with reference to FIG. 1.

At operation 430, the method may include updating prediction models with the scenario and CSI quantity information. The operations of step 430 may be performed in accordance with examples as described herein. In some implementations, aspects of the operations of step 430 may be performed by a device as described with reference to FIG. 1.

In some implementations, the UE 104 can associate the available/supported ML models with an ID number and transmit the request for model training with the ID identifying the model for which the training is requested. The network can send requests for UE measurements and reporting related to the CSI prediction accuracy using a model ID and/or a subset of the model defining parameters included in the UE capability message. Further, the UE can indicate, via the information message, the UE capability to run multiple computational models in parallel. The network can then indicate multiple models for the purpose of model training, CSI prediction, measurement and reporting, and/or various combinations.

In some implementations, such as when the network employs ML models for aging compensation/CSI prediction assistance, the network can request from the UE 104 act as a trainer by providing additional information from previous time instances or periods. The network can indicate to the UE 104 to continue CSI measurement/estimation on a previous time instance, such as by collecting, storing, and/or processing data related to a previous CSI instance. The UE 104 can report the estimated CSI value with higher accuracy to the network, such as within a UE capability or information message.

In some cases, such as when the output parameter to be estimated lives in a discrete domain, the network configures the UE 104 to obtain a predicted label as an input for model training, following a configured decision-feedback training process when the measured prediction accuracy is above a certain threshold. The network can indicate the threshold for the decision-feedback training process via dynamic signaling (e.g., a PDCCH DCI).

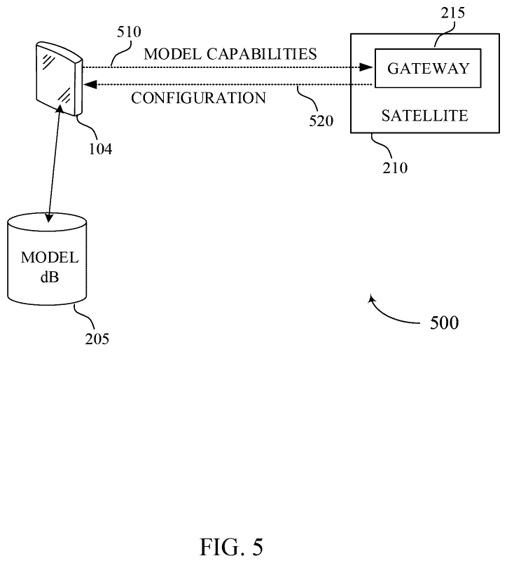

In some aspects, the network, via the base station 102, configures the type of AI/ML model architecture and the applicable scenario to be used by the UEs when performing predictions of channel quantities of the NTN. FIG. 5 illustrates an example of a block diagram 400 that supports network configuration of prediction models in UE in accordance with aspects of the present disclosure.

The base station 102 can configure the prediction models in response to receiving information from the UE 104 about model capabilities, or without the capability information. For example, the UE 104 can model capability information 510 to the network gateway 215, which utilizes the information to transmit configuration instructions 520 back to the UE 104.

In some implementations, the network configures one or more of the prediction models for each quantity to be predicted by the UE 104, such as the following quantities to be predicted in order to compensate for aged information: SSB-index and SINR, SSBRI, SS-RSRP, SS-RSRQ, SS-SINR, CRI and RI, CRI and CQI, and/or CRI and PMI. The network gateway 215 can pre-define a table with a list of quantities for which models are to be configured, or the network gateway can send the table through RRC signaling. For example, the network gateway 215 can transmit an index corresponding to respective quantities (shown in Table 3) through L1/L2 signaling.

TABLE 3

| Index | Quantities |
|---|---|
| 0 | All |
| 1 | SSB |
| 2 | CSI-All |
| 3 | CRI |
| 4 | CQI |
| 5 | RI |
| 6 | PMI |

Referring to Table 3, the index refers to an individual quantity, combination of the quantities, or all quantities to be predicted by the models employed by the UE 104. For example, index 0 in Table 3 relates to all quantities requiring prediction, while index 2 relates to all quantities in the CSI-report requiring prediction. Of course, in some cases, the network can identify the quantities to be predicted by the UE 104.

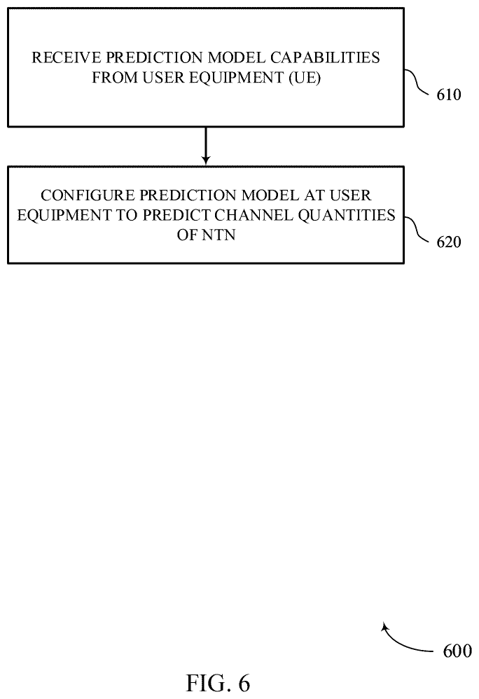

FIG. 6 illustrates a flowchart of a method 600 that supports configuring prediction models for UE in accordance with aspects of the present disclosure. The operations of the method 600 may be implemented by a device or its components as described herein. For example, the operations of the method 600 may be performed by the base station 102 as described with reference to FIG. 8. In some implementations, the device may execute a set of instructions to control the function elements of the device to perform the described functions. Additionally, or alternatively, the device may perform aspects of the described functions using special-purpose hardware.

At operation 610, the method may include receiving prediction model capabilities from UE, such as UE 104. The operations of step 610 may be performed in accordance with examples as described herein. In some implementations, aspects of the operations of step 610 may be performed by a device as described with reference to FIG. 1.

At operation 620, the method may include configuring the prediction model the UE to predict channel quantities of the NTN. The operations of step 620 may be performed in accordance with examples as described herein. In some implementations, aspects of the operations of step 620 may be performed by a device as described with reference to FIG. 1.

In some cases, such as for predictions of SSB values, the network may not know the capabilities of the UE 104. The network, in such cases, can transmit or otherwise indicate a list of AI/ML models, such as via the SIB, to be used for SSB predictions. If/when the UE 104 has one or more prediction model capabilities, the UE 104 can select a suitable model (e.g., the most suitable) use the selected model for the SSB prediction. The UE 104 can then transmit the prediction to the network along which information identifying the prediction model used when performing the SSB prediction.

In some cases, such as when CSI related quantities are to be predicted and the UE 104 or UEs have indicated their AI/ML model capabilities, the network can configure the type of AI/ML model architecture, the applicable scenario, and/or the quantities to be predicted through RRC signaling. For example, the gNB 215 can utilize three fields in DCI corresponding to the three indices from Table 1, 2, and 3 to dynamically configure the type of AI/ML model architecture, the applicable scenario, and/or the quantities to be predicted. Further, as described herein, the gNB 215 can utilize a common group DCI and transmit configuration instructions to a group of UEs sharing a common ID or otherwise grouped for signaling/messaging purposes.

In some implementations, the network can configure the AI/ML model, the applicable scenario, and/or the quantities to be predicted as part of a cell handover procedure. For example, an NTN supported by LEO satellites can utilize handover procedures for configuration because there are frequent cell handovers due to the mobility of the satellites. When utilizing cell handovers, the network can configure the parameters to be predicted through SIB or through RRC signaling. Further, the network can transmit assistance information, to be used when configuring models, between the cells that are part of the cell handover (from the first cell to the subsequence cell in the handover).

The network, via the gNB 215, can indicate various assistance information when configuring prediction models for UEs. For example, the network can indicate separate model types/parameters for different prediction parameters. Thus, multiple prediction parameters utilize the same prediction AI/ML model, with multiple outputs from the output layer of the model, representing different intended prediction metrics.

Further, in addition to the values to be predicted, the network can configure the UE 104 to indicate or send a prediction quality indicator for each specific parameter that is predicted. The quality indicator can include a measure of prediction error (e.g., MSE or an absolute relative error, as a percentage of the true value of the parameter, and/or an information divergence measure, such as KLD).

In some implementations, the network can configure certain quantities before or prior to a hard feeder link switch over, where a switch-over from one satellite-gateway link to another satellite-gateway link is hard without a soft overlap. Before the transition from one link to the next link, the network can configure the following quantities: assistance information associated with the next satellite/gateway, AI/ML model type and parameters, applicable scenarios, quantities that require prediction, and/or the timing validity of configured information. In some cases, the network configured the quantities through SIB and/or through common group signaling, such as for a group of UEs that are already performing predictions for the previous serving cell.

In some implementations, the UE 104, or other UEs, can assist the network with configuring its AI/ML prediction models. For example, the network can configure the model employed by UE 104 and the parameters to be predicted based on reports from other UEs that identify the prediction success rates at the UEs.

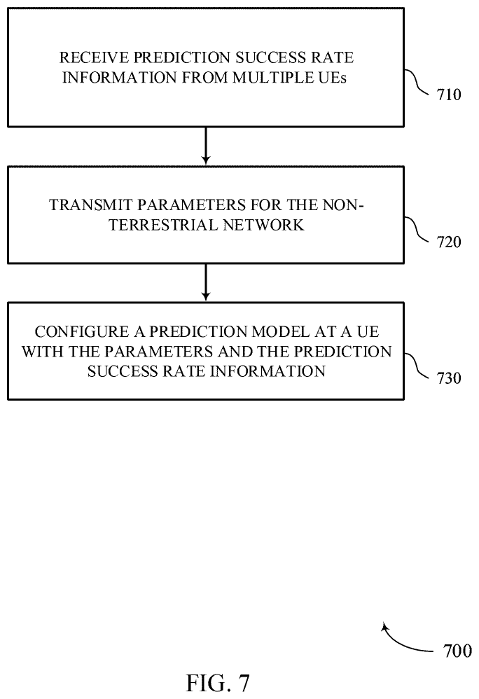

FIG. 7 illustrates a flowchart of a method 700 that supports configuring prediction models using UE success rate information in accordance with aspects of the present disclosure. The operations of the method 700 may be implemented by a device or its components as described herein. For example, the operations of the method 700 may be performed by the base station 102 as described with reference to FIG. 8. In some implementations, the device may execute a set of instructions to control the function elements of the device to perform the described functions. Additionally, or alternatively, the device may perform aspects of the described functions using special-purpose hardware.

At operation 710, the method may include receiving prediction success rate information from multiple UEs. The operations of step 710 may be performed in accordance with examples as described herein. In some implementations, aspects of the operations of step 710 may be performed by a device as described with reference to FIG. 1.

At operation 720, the method may include transmitting the parameters for the NTN. The operations of step 720 may be performed in accordance with examples as described herein. In some implementations, aspects of the operations of step 720 may be performed by a device as described with reference to FIG. 1.

At operation 730, the method may include configuring a prediction model at a UE with the parameters and with the prediction success rate information. The operations of step 730 may be performed in accordance with examples as described herein. In some implementations, aspects of the operations of step 730 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

As described herein, the network can configure the AI/ML model, the applicable scenario, and/or the quantities that require prediction to the UEs. The different UEs can employ different models, or similar models with different weight factors, realizing different prediction success rates for the different models or weight factors. Using the prediction model accuracy, the network can configure the model with the highest accuracy to other UEs, while utilizing the AI/ML model parameters. In some cases, the UE reporting can include, by default, the prediction model accuracy parameter for any employed prediction model. In some cases, the UE can indicate the prediction model accuracy parameter when requested or specified by the network in the reporting configuration. Further, the UE can select the model accuracy parameter based on the quantities to be predicted. For example, the AI/ML model prediction accuracy parameter can define the model success rate as a percentage or as a ratio, such as a ratio selected from a set of pre-defined ratios.

In some embodiments, the UE 104 measures the success rate and/or prediction accuracy via a received configuration from the network, where the configuration indicates a time window for which the model output accuracy is to be measured. For example, the UE 104 measures the success rate and prediction accuracy based on the comparison of the predicted value and the estimated value at a later point in time. As another example, the network informs the UE 204 of the actual value, or a value history, for the parameters to be predicted by the UE 204. The network can direct the UE 204 to store the predicted values of the previous point in time for a given time duration and measure the prediction accuracy by comparing the stored predicted values to the correct values later indicated by the network.

Based on the reported prediction accuracy by the UEs, the network can configure the UEs to send the used AI/ML model-defining parameters, including a parameterized model architecture, the model weights, and/or a compressed version of the model weights based on an indicated compression strategy. The network can send the configuration instructions to the UEs dynamically through DCI or through the MAC control element (MAC CE).

The UE can indicate the weight factors to the network in a quantized way by employing a pre-defined quantization format or by a specific format indicated by the network. The UE can indicate the model weights factor along with the prediction accuracy parameters to the network. The network can define the AI/ML model prediction accuracy threshold, and the UEs, based on the threshold values, can transmit the quantized model weight factors along with the prediction output. For example, a 90% accuracy threshold value is set by the network. All UEs that achieve 90% or higher accuracy send their model weight factors in a specified quantity report to the network.

In some cases, such as when the same model layers are used to predict multiple parameter/metrics at the same time, the accuracy measure can include a weighted combination of all parameter prediction accuracies, a joint measure of all prediction accuracies, or a combination of the prediction accuracies.

In some cases, the threshold parameter or value is set in the same RRC configuration where the AI/ML model and related parameters are configured. The network can configure the threshold parameter along with RRC reporting configuration parameters and/or dynamically through DCI. The network can also condition the reporting of the model weights/model-defining parameters via a request to the UE. Further, the network can dynamically set the threshold for which the UE model parameters are transferred to the network, such as based on model availability at the network with a specific accuracy.

FIG. 8 illustrates an example of a block diagram 800 of the UE 802, which supports predicting channel aging compensation quantities for NTNs in accordance with aspects of the present disclosure. The device 802 may be an example of the UE 104 (or the base station 102, such as the gNB 215 of the satellite 210), as described herein. The device 802 may support wireless communication with one or more base stations 102, UEs 104, or any combination thereof. The device 802 may include components for bi-directional communications including components for transmitting and receiving communications, such as a communications manager 804, a processor 806, a memory 808, a receiver 810, transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication at a first device (e.g., the device 802) in accordance with examples as disclosed herein. The communications manager 804 may be configured as or otherwise support a means for predicting channel aging compensation quantities (e.g., CSI quantities) for NTNs, as described herein. For example, the communications manager 804 can receive parameters associated with an NTN, select an AI/ML prediction model based on the received parameters for CSI aging compensation, and apply the selected AI/ML prediction model to predict one or more CSI quantities to compensate for CSI aging phenomenon in the NTNs.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

In addition to supporting wireless communication at a first device, such as the UE 104, the communications manager 804, when implemented as part of the base station 102, can support wireless communication at a second device (e.g., the device 802) in accordance with examples as disclosed herein. The communications manager 804 may be configured as or otherwise support a means for configuring prediction models for UE, as described herein. For example, the communications manager can receive information from at least one other UE that indicates prediction success rates for the other UE for predictions of one or more CSI quantities for CSI aging compensation, transmit parameters associated with the NTN, and configure an AI/ML prediction model based on the parameters associated with the NTNs or based on the information received from the at least one other UE that that indicates the prediction success rates for the other UE.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive one or more parameters associated with a non-terrestrial network;
select an artificial intelligence/machine learning (AI/ML) prediction model, based on the one or more parameters, for channel state information (CSI) aging compensation; and
apply the selected AI/ML prediction model to predict one or more CSI quantities to compensate for CSI aging phenomenon in the non-terrestrial networks.

2. The UE of claim 1, wherein the apparatus receives the one or more parameters associated with the non-terrestrial network via radio resource control (RRC) signaling.

3. The UE of claim 1, wherein the apparatus receives, from a network entity, a system information block (SIB) including the one or more parameters associated with the non-terrestrial network.

4. The UE of claim 1, wherein the one or more parameters associated with the non-terrestrial network include a current orbit of a satellite of the non-terrestrial network, a current position of the satellite of the non-terrestrial network, or a speed vector defining a current speed of the satellite of the non-terrestrial network, or any combination thereof.

5. The UE of claim 1, wherein the one or more parameters associated with the non-terrestrial network include a cell layout configuration for one or more cells of the non-terrestrial network, a weather condition within the non-terrestrial network, or an atmospheric condition within the non-terrestrial network, or any combination thereof.

6. The UE of claim 1, wherein the UE is associated with a group of UEs for receiving the one or more parameters associated with the non-terrestrial network; and wherein the group of UEs are grouped based on a respective location associated with each respective UE of the group of UEs, a channel aging type associated with each respective UE of the group of UEs, or a respective prediction modeling capability of each respective UE of the group of UEs, or any combination thereof.

7. The UE of claim 1, wherein the at least one processor is further configured to cause the UE to transmit one or more prediction model capabilities of the UE to the non-terrestrial network.

8. The UE of claim 1, wherein the at least one processor is further configured to cause the UE to transmit one or more prediction model capabilities and associated model training deficiencies of the UE to the non-terrestrial network.

9. The UE of claim 1, wherein the at least one processor is further configured to cause the UE to select the AI/ML prediction model based on the one or more parameters associated with the non-terrestrial network and without additional information from the non-terrestrial network.

10. The UE of claim 1, wherein the at least one processor is further configured to cause the UE to:
transmit prediction model capabilities and associated model training deficiencies of the UE to the non-terrestrial network;
receive, from the non-terrestrial network, prediction scenario information and channel state information quantity information; and
update prediction models of the UE using the prediction scenario information and channel state information quantity information received from the non-terrestrial network.

11. The UE of claim 1, wherein the selected AI/ML prediction model includes a deep neural network model, a linear regression model, a support vector machines model, a learning vector quantization model, or a decision tree model.

12. A method performed by user equipment (UE), the method comprising:
receiving one or more parameters associated with a non-terrestrial network;
selecting an artificial intelligence/machine learning (AI/ML) prediction model based on the one or more parameters associated with the non-terrestrial network; and
applying the selected AI/ML prediction model to predict one or more channel state information (CSI) quantities of the non-terrestrial network.

13. The method of claim 12, wherein the UE receives the one or more parameters associated with the non-terrestrial network via radio resource control (RRC) signaling.

14. The method of claim 12, wherein the UE receives, from the network entity, a system information block (SIB) including the one or more parameters associated with the non-terrestrial network.

15. (canceled)

16. A network entity of a non-terrestrial network, the network entity comprising:
at least one memory; and
at least one processor coupled with the at least one processor and configured to cause the network entity to:
receive information from at least one user equipment (UE) that indicates prediction success rates for the UE for predictions of one or more channel state information (CSI) quantities for CSI aging compensation;
transmit one or more parameters associated with the non-terrestrial network; and
configure an artificial intelligence/machine learning (AI/ML) prediction model based on the parameters associated with the non-terrestrial networks or based on the information received from the at least one UE that indicates the prediction success rates for the UE.

17. The network entity of claim 16, wherein the information received from the at least one UE includes information that identifies the AI/ML prediction models utilized by the at least one UE when predicting CSI quantities for the non-terrestrial network.

18. (canceled)

19. The network entity of claim 16, wherein the at least one processor is configured to cause the network entity to configure the prediction model employed by the UE by adding a prediction model accuracy parameter to a report that identifies from the received information a prediction model having a highest success rate for predicting the one or more CSI quantities for CSI aging compensation of the non-terrestrial network.

20. The network entity of claim 16, wherein the at least one processor is configured to cause the network entity to configure the prediction model employed by the UE by adding a prediction model accuracy parameter to a report that identifies from the received information a prediction model having a highest success rate for predicting the one or more CSI quantities for CSI aging compensation of the non-terrestrial network.

21. A processor for wireless communication, comprising:
at least one controller coupled with at least one memory and configured to cause the processor to:
receive one or more parameters associated with a non-terrestrial network;
select an artificial intelligence/machine learning (AI/ML) prediction model, based on the one or more parameters, for channel state information (CSI) aging compensation; and
apply the selected AI/ML prediction model to predict one or more CSI quantities to compensate for CSI aging phenomenon in the non-terrestrial networks.
